(19) United States
(12) Patent Application Publication
(10) Pub. No.: US 2008/0096677 A1
(43) Pub. Date: Apr. 24, 2008

(54) Weld yoke assembly

(76) Inventors: Patrick L. Kurzeja, White Lake, MI (US); Anthony G. Lentini, St. Clair Shores, MI (US); William A. Konior, Clinton Township, MI (US); Christopher J. Steele, Lake Orion, MI (US); Joseph W. Londeree, Manning, SC (US)

Correspondence Address: CARLSON, GASKEY & OLDS, P.C., 400 WEST MAPLE ROAD, SUITE 350, BIRMINGHAM, MI, 48009, US

(21) Appl. No.: 11/582,583

(22) Filed: Oct. 18, 2006

(51) Int. Cl. F16D 3/00

(52) U.S. Cl. 464/134

(57) ABSTRACT

A yoke assembly for a vehicle driveline includes a first component and a second component that are welded together. The first component comprises a yoke with an internal pilot surface. The second component comprises a tube or shaft having an external surface that abuts against the internal pilot surface. A single weld is then used to secure the yoke to the tube or shaft.

### TECHNICAL FIELD

The present application relates to a yoke assembly for a vehicle driveline.

### BACKGROUND OF THE INVENTION

Vehicle drivelines include yoke assemblies that are used to connect rotating drive shafts to other driveline components allowing transmission of driving torque from a vehicle engine to a drive axle. One traditional type of yoke assembly includes a shaft that is attached to a yoke. A short tube is used to connect the shaft to the yoke.

Ends of the shaft and yoke are inserted into the tube such that the tube surrounds the ends of the shaft and yoke. One end of the tube is then welded to the shaft and an opposite end of the tube is welded to the yoke.

Manufacturing constraints require that the welding be completed in two separate passes. This is due to the short length of the tube, which places the two welds in close axial proximity. Because the two welds are so close together, it is impossible to use a multi-weld head tool. As such, one welding pass must be performed to secure one end of the tube to the shaft, and a separate, second welding pass must be performed to secure the other end of the tube to the yoke. Further, a predetermined period of time must pass before the second welding pass can be performed so that the first weld can cool.

This welding process is time consuming and expensive. Further, the welding process can result in heat distortion within the yoke assembly, which increases the difficulty in attempts to balance the driveline.

Thus, there is a need for an improved connection interface for the yoke assembly that eliminates the need for multiple welds, in addition to overcoming the other above-mentioned difficulties in the prior art.

### SUMMARY OF THE INVENTION

A yoke assembly for a driveline includes a yoke that is welded to another driveline component. The yoke includes an internal pilot surface that abuts against an external surface of the driveline component.

In one disclosed example, the yoke includes a shaft portion with an internal cavity that defines the internal pilot surface, and a pair of yoke arms that extend outwardly from the shaft portion. One end of the driveline component is inserted into the internal cavity such that the external surface abuts directly against the internal pilot surface in an overlapping relationship. A single weld is then used to secure the yoke to the driveline component.

In one example, the driveline component comprises a shaft having a splined connection at one end for coupling with another driveline component. An opposite end of the shaft is inserted into the internal cavity and is welded to the yoke.

By attaching the shaft and the yoke directly together the need for a balance correction is eliminated. Additionally, as only one weld is required to secure the shaft and yoke together, assembly time and component cost is significantly reduced.

These and other features of the present invention can be best understood from the following specification and drawings, the following of which is a brief description.

### BRIEF DESCRIPTION OF THE DRAWINGS

FIG. 1 is a side view, shown in partial cross-section, of a yoke assembly according to the prior art.

FIG. 2 is a side view, shown in partial cross-section, of a yoke assembly incorporating the subject invention.

FIG. 3 is a side view, shown in partial cross-section, of another yoke assembly incorporating the subject invention.

### DETAILED DESCRIPTION OF THE PREFERRED EMBODIMENT

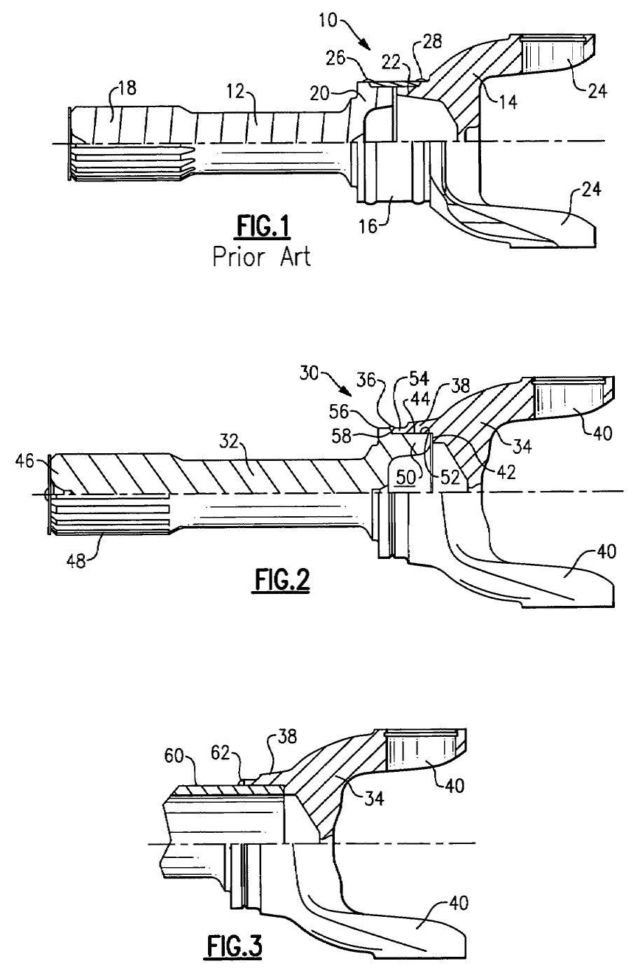

A prior art yoke assembly is shown generally at 10 in FIG. 1. The yoke assembly 10 includes a shaft 12 and a yoke 14 that are attached to each other with a tube 16. The shaft 12 is a male shaft having a first end 18 with a spline connection for coupling with another driveline component and a second end 20 that is coupled to the yoke 14.

The yoke 14 is a male yoke having a solid shaft portion 22 and a pair of yoke arms 24. The tube 16 surrounds the solid shaft portion 22 and the second end 20 of the shaft 12. A first end of the tube 16 is welded to the second end 20 of the shaft 12 with a first weld 26 and a second end of the tube 16 is welded to the solid shaft portion 22 of the yoke 14 with a second weld 28.

Due to the short length of the tube 16, manufacturing constraints require that the first 26 and second 28 welds be performed with separate welding passes. A waiting period is also required between welds to allow the first weld to cool. This is a time consuming and expensive process. Further, the use of multiple welds increases the likelihood of heat distortion in the components, which results in increased difficulty for balancing the driveline after assembly.

The present invention eliminates the need for multiple welds. As shown in FIG. 2, a yoke assembly incorporating the subject invention is shown generally at 30. The yoke assembly 30 includes a shaft 32 and a yoke 34. The yoke 34 is attached directly to the shaft 32 with a single weld 36.

The yoke 34 includes a shaft portion 38 and a pair of yoke arms 40 that extend outwardly from the shaft portion 38. The shaft portion 38 includes an internal cavity 42 that defines an internal pilot surface 44.

The shaft 32 includes a first end 46 with a splined surface 48 for coupling with another driveline component (not shown) and a second end 50 that is inserted into the internal cavity 42. An external surface 52 of the second end 50 abuts directly with the internal pilot surface 44 in an overlapping relationship.

The shaft 32 also includes an increased diameter portion 56 that forms an abutment stop 58. A distal end 54 of the shaft portion 38 of the yoke 34 abuts against the abutment stop 58 when the second end 50 is inserted into the internal cavity 42. The weld 36 is formed about an outer circumference of the yoke assembly 30 in the area of the distal end 54 of the yoke 34 and the increased diameter portion 56 of the shaft 32.

The shaft 32 can comprise a solid shape with a spline plug as shown in FIG. 3, or the shaft 32 can comprise a tubular member 60 as shown in FIG. 3. The tubular member 60 could be a straight tube as shown or could include an increased diameter portion similar to that shown in FIG. 2. A single weld 62 is all that is required to secure the yoke 34 to the tubular member 60.

Forming the yoke to have an internal piloting surface eliminates the need for a tubular connector piece between the yoke and the shaft, resulting in a reduced number of components. Further, only a single weld is required which reduces problem of heat distortion and balance correction. This allows greater throughput in the manufacturing process, as well as reducing overall cost.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A yoke assembly for a vehicle driveline comprising:
a driveline component having a first connection interface at a first end and a second connection interface at a second end; and
a yoke having an attachment end with an internal pilot surface that surrounds one of said first and said second ends, said yoke being directly fixed to said driveline component with a weld interface between said attachment end and said one of said first and said second ends.

2. The yoke assembly according to claim 1 wherein said weld interface comprises a single weld.

3. The yoke assembly according to claim 2 wherein said single weld is formed about an external surface of said attachment end of said yoke and an external surface of said one of said first and said second ends.

4. The yoke assembly according to claim 1 wherein said driveline component comprises a shaft with said first connection interface comprising a spline connection for coupling with another driveline component, and with said attachment end of said yoke being fixed to said second connection interface.

5. The yoke assembly according to claim 1 wherein said yoke includes a shaft portion and a pair of yoke arms that extend outwardly from said shaft portion, and wherein said shaft portion includes an internal cavity that defines said internal pilot surface.

6. The yoke assembly according to claim 5 wherein said one of said first and said second ends of said driveline component is inserted into said internal cavity and includes an external peripheral surface that directly abuts against internal pilot surface in an overlapping relationship.

7. The yoke assembly according to claim 6 wherein said driveline component includes an abutment flange formed about said one of said first and said second ends, and wherein a distal end of said attachment end of said yoke abuts against said abutment flange when said one of said first and said second ends is inserted into said internal cavity.

8. The yoke assembly according to claim 7 wherein said weld interface comprises a single weld in an area between said distal end and said abutment flange.

9. The yoke assembly according to claim 1 wherein said driveline component comprises a tube with said first connection interface adapted for coupling with another driveline component, and with said attachment end of said yoke being fixed to said second connection interface of said tube.

10. A yoke assembly for a vehicle driveline comprising:
a yoke including a shaft portion and a pair of yoke arms extending outwardly from said shaft portion, said shaft portion having an internal cavity that defines an internal pilot surface;
a driveline shaft having a first connection interface at a first end for coupling with a driveline component and a second connection interface at a second end for coupling with said yoke, said second end being received within said internal cavity to engage said internal pilot surface; and
a weld that secures said second end of said driveline shaft to said shaft portion of said yoke.

11. The yoke assembly according to claim 10 wherein said weld comprises a single weld.

12. The yoke assembly according to claim 10 wherein an external peripheral surface of said second end of said driveline shaft abuts directly against said internal pilot surface in an overlapping relationship.

13. The yoke assembly according to claim 10 wherein said driveline shaft includes an increased diameter portion formed about said second end, and wherein a distal end of said shaft portion abuts against said increased diameter portion when said second end is inserted into said internal cavity.

14. The yoke assembly according to claim 13 wherein said weld comprises a single weld that attaches said distal end to said increased diameter portion.

15. A method of assembling a two-piece yoke assembly comprising the step of:
(a) engaging one end of a driveline component against an internal pilot surface of a yoke; and
(b) welding the yoke to the driveline component.

16. The method according to claim 15 wherein step (b) comprises providing a single weld between the yoke and the driveline component.

17. The method according to claim 15 including providing the yoke with a shaft portion having an internal cavity defining the internal pilot surface, and a pair of yoke arms extending outwardly from the shaft portion; and wherein step (a) includes inserting the one end of the driveline component into the internal cavity such that an external surface of the driveline component abuts directly against the internal pilot surface.

18. The method according to claim 15 wherein the driveline component comprises a shaft having a spline connection at a first end for connection to another driveline component and a second end opposite the first end; and wherein step (a) includes abutting an external surface of the second end directly the internal pilot surface.
